(19) United States
(12) Patent Application Publication
(10) Pub. No.: US 2026/0369914 A1
(43) Pub. Date: Nov. 19, 2026

(54) POP-UP ELECTRICAL OUTLET

(71) Applicant: EATON INTELLIGENT POWER LIMITED, DUBLIN 4 (IE)

(72) Inventors: Andrew Joshua Jackson, Atlanta, GA (US); Girish Mruthunjaya, Marietta, GA (US)

(73) Assignee: EATON INTELLIGENT POWER LIMITED, DUBLIN 4 (IE)

(21) Appl. No.: 19/212,045

(22) Filed: May 19, 2025

(51) Int. Cl. H01R 13/44

(52) U.S. Cl. CPC H01R 13/44

(57) ABSTRACT

Disclosed herein are pop-up electrical outlets. The described pop-up electrical outlets include a middle housing configured to be installed within an opening of a horizontal surface, a lower housing coupled to a bottom of the middle housing, and a receptacle component housing electrical receptacles and configured to slidably move vertically within the middle housing to various states. Components for supporting, guiding, and/or locking the receptacle component in the various states are arranged in a perimeter area of the pop-up electrical outlet and/or within the lower housing. The internal conductors for providing electrical connectivity are arranged within a central area of the pop-up electrical outlet and coupled to independent wire terminals. The pop-up electrical outlet may have a form factor with reduced physical dimensions, including reduced profile and height characteristics. The pop-up electrical outlet may facilitate reduced strain, flexion, and/or tension on the internal conductors.

### TECHNICAL FIELD

The present disclosure is directed to an electrical outlet configured to be mounted within a horizontal surface, such as a countertop or work surface, and, in particular, to a water-resistant and recessed pop-up electrical outlet with a bottom housing that includes locking and guiding features for controlling movement of a receptacle component of the pop-up electrical outlet.

### BACKGROUND

Electrical outlets may be permanently installed within or on horizontal surfaces, such as countertops, desktops, work surfaces, and/or the like. A pop-up electrical outlet is an outlet system configured to be installed within a recess of a horizontal surface. The pop-up electrical outlet includes one or more receptacles arranged in a housing configured to be stored below or flush with the horizontal surface and to be raised or “pop up” above the horizontal surface for use providing power to electrical devices. Although convenient, pop-up electrical outlets are prone to the intrusion of water and other unwanted elements, particularly in the popular installation location of kitchen islands and countertops. In addition, pop-up electrical outlets require moving components that facilitate the travel of the plug receptacles below and above the horizontal surface. As a result, conventional pop-up outlets typically require large, bulky housings in order to accommodate both component movement and electrical wiring. Furthermore, whether housed in a bulky form factor or not, the configuration of the moving components of conventional pop-up outlets causes excessive movement and strain on the internal electrical wiring when the receptacles of the pop-up electrical outlet are traveling above and below the horizontal surface.

The susceptibility of conventional pop-up outlets to both water intrusion and electrical wiring strain leads to damaged electrical components and dangerous operating conditions.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

The present disclosure describes various embodiments of an improved pop-up electrical outlet. In one embodiment, a pop-up electrical outlet may include a middle housing configured to be installed within an opening of a horizontal surface; a lower housing coupled to a bottom of the middle housing; a receptacle component that includes at least one electrical receptacle and is configured to slidably move within the middle housing vertically upward to an extended state above the horizontal surface and vertically downward to a retracted state below the horizontal surface, in which movement of the receptacle component within the middle housing is guided by at least one guide extending vertically within the middle housing, the at least one guide having a lower end coupled to the lower housing and an upper end configured to be received within a channel arranged within a lateral wall of the receptacle component; and at least one retracted locking assembly arranged on an external lateral surface of the receptacle component, the at least one retracted locking assembly configured to be releasably latched with a latching component arranged in the lower housing when the receptacle component is in the retracted state.

In some embodiments of the pop-up electrical outlet, the pop-up electrical outlet further includes a plurality of independent wire terminals arranged within the middle housing to electrically connect external conductors of a power source to internal conductors electrically coupled to the at least one electrical receptacle.

In various embodiments of the pop-up electrical outlet, the pop-up electrical outlet further includes at least one spring arranged around the at least one guide, the at least one spring configured to bias the receptacle component vertically upward.

In exemplary embodiments of the pop-up electrical outlet, the receptacle component is configured to be arranged in an intermediate state between the extended state and the retracted state, the receptacle component supported at least partially by the at least one spring in the intermediate state with an intermediate portion of the receptacle component arranged above the horizontal surface.

In various embodiments of the pop-up electrical outlet, the pop-up electrical outlet further includes internal conductors configured to electrically connect the at least one electrical receptacle to a power source, the internal conductors extending within a central area of the middle housing, wherein the at least one guide, and the at least one retracted locking assembly are arranged within the middle housing in a perimeter area outside of the central area.

In illustrative embodiments of the pop-up electrical outlet, the internal conductors include a first length enclosed within the receptacle component in each of the extended state, the intermediate state, and the retracted state, the first length having one or more affixed portions affixed to an interior surface of the receptacle component to cause the first length to move in parallel with the receptacle component.

In some embodiments of the pop-up electrical outlet, the internal conductors include a second length enclosed within a central area of the middle housing in each of the extended state, the intermediate state, and the retracted state, wherein the second length is configured to move into the receptacle component through openings in a bottom of the receptacle component as the receptacle component moves vertically downward within the middle housing.

In various embodiments of the pop-up electrical outlet, the first length is arranged above the middle housing when the receptacle component is in the extended state, and the second length is arranged outside of and below the receptacle component when the receptacle component is in the extended state.

In exemplary embodiments of the pop-up electrical outlet, the second length is enclosed within both the receptacle component and the middle housing when the receptacle component is in the retracted state.

In various embodiments of the pop-up electrical outlet, the receptacle component is configured to move into and out of the middle housing via a middle housing opening, the middle housing opening having an internal sidewall associated with a sealing component configured to form a water-resistant seal between the sidewall and each of a plurality of sides of the receptacle component.

In one embodiment, a pop-up electrical outlet may include a middle housing configured to be installed within an opening of a horizontal surface; a lower housing coupled to a bottom of the middle housing; a receptacle component including at least one electrical receptacle and configured to slidably move vertically within the middle housing to an extended state above the horizontal surface, a retracted state below the horizontal surface, and an intermediate state between the extended state and the retracted state; and internal conductors configured to electrically connect the at least one electrical receptacle to a power source, in which the internal conductors include a first length enclosed within the receptacle component in each of the extended state, the intermediate state, and the retracted state, the first length having one or more affixed portions affixed to an interior surface of the receptacle component to cause the first length to move in parallel with the receptacle component, and a second length enclosed within a central area of the middle housing in each of the extended state, the intermediate state, and the retracted state, wherein the second length is configured to move into the receptacle component through openings in a bottom of the receptacle component as the receptacle component moves vertically downward within the middle housing.

In some embodiments of the pop-up electrical outlet, the pop-up electrical outlet further includes a plurality of independent wire terminals arranged within the middle housing to electrically connect external conductors of a power source to internal conductors electrically coupled to the at least one electrical receptacle.

In various embodiments of the pop-up electrical outlet, the first length is arranged above the middle housing when the receptacle component is in the extended state.

In some embodiments of the pop-up electrical outlet, the second length is arranged outside of and below the receptacle component when the receptacle component is in the extended state.

In exemplary embodiments of the pop-up electrical outlet, the second length is enclosed within both the receptacle component and the middle housing when the receptacle component is in the retracted state.

In various embodiments of the pop-up electrical outlet, movement of the receptacle component within the middle housing is guided by at least one guide extending vertically within the middle housing, the at least one guide having a lower end coupled to the lower housing and an upper end configured to be received within a channel arranged in a lateral side wall of the receptacle component.

In some embodiments of the pop-up electrical outlet, the pop-up electrical outlet further includes at least one retracted locking assembly arranged on an external lateral surface of the receptacle component, the at least one retracted locking assembly configured to be releasably latched with a latching component arranged in the lower housing when the receptacle component is in the retracted state.

In one embodiment, a receptacle component for a pop-up electrical outlet may include a body having a pair of opposing lateral walls and a front face orthogonal to the lateral walls, the body configured to slidably move vertically within a middle housing to an extended state above the horizontal surface, a retracted state below the horizontal surface, and an intermediate state between the extended state and the retracted state; at least one electrical receptacle accessible via the front face of the body; a pair of channels, each of the pair of channels arranged within one of the pair of opposing lateral walls and configured to receive one of a pair of guides to guide movement of the receptacle component within the middle housing; at least one retracted locking assembly arranged on an external lateral surface of the receptacle component, the at least one retracted locking assembly configured to be releasably latched with a latching component arranged in the lower housing when the receptacle component is in the retracted state; and at least one spring arranged around the at least one guide, the at least one spring configured to bias the receptacle component vertically upward.

In some embodiments of the receptacle component for a pop-up electrical outlet, the receptacle component is configured to be arranged in the intermediate state supported at least partially within the middle housing by the at least one spring with an intermediate portion of the receptacle component arranged above the horizontal surface.

In some embodiments of the receptacle component for a pop-up electrical outlet, the pair of channels and the least one retracted locking assembly are configured to move within a perimeter area of the middle housing, external to a central area of the middle housing having internal conductors arranged therein.

### BRIEF DESCRIPTION OF THE DRAWINGS

By way of example, features of the disclosed components and systems are described with reference to the accompanying drawings, in which:

FIG. 1 depicts a perspective front view of an illustrative example of a pop-up electrical outlet in accordance with the present disclosure;

FIG. 2A depicts an exploded perspective front view of an illustrative example of a pop-up electrical outlet in accordance with the present disclosure;

FIG. 2B depicts an exploded perspective sectional view of an illustrative example of a pop-up electrical outlet in accordance with the present disclosure;

FIG. 3 depicts a perspective sectional view of an illustrative example of a middle housing in accordance with the present disclosure;

FIG. 4 depicts a perspective view of an illustrative example of a lower housing in accordance with the present disclosure;

FIG. 5A depicts top-down view of an illustrative example of a pop-up electrical outlet installed in a horizontal surface in accordance with the present disclosure;

FIG. 5B depicts a side view of an illustrative example of a pop-up electrical outlet installed in a horizontal surface in accordance with the present disclosure;

FIG. 6A depicts a front perspective view of positional states of a pop-up electrical outlet in accordance with the present disclosure;

FIG. 6B depicts a sectional perspective view of positional states of a pop-up electrical outlet in accordance with the present disclosure;

FIG. 7 depicts a front view of an illustrative example of a pop-up electrical outlet in accordance with the present disclosure; and

FIGS. 8A and 8B depict various perspective views of an illustrative example of a receptacle component in accordance with the present disclosure.

### DETAILED DESCRIPTION

Various features of an improved pop-up electrical outlet are described in the present disclosure, with reference to the accompanying drawings, in which one or more features of the pop-up electrical outlet are shown and described. The various features described in the present disclosure and depicted in the accompanying drawings may be used independently of, or in combination with, each other. A pop-up electrical outlet as disclosed herein may be embodied in many different forms and should not be construed as being limited to the examples set forth herein. Rather, these examples are provided to convey certain features of the pop-up electrical outlet to those skilled in the art.

A pop-up electrical outlet of the described embodiments may be installed within a recess or other opening of a horizontal surface, such as a countertop, a work surface, a desktop, and/or the like. The pop-up electrical outlet may include a receptacle component (or upper housing or upper body), a middle housing (or middle body), and a lower housing (or lower body).

The middle housing may be configured to be arranged within the recess of the horizontal surface. The middle housing may include an upper mounting surface (or surfaces) configured to be coupled with the horizontal surface and a cavity that extends below the horizontal surface. In some embodiments, the middle housing may include one or more gaskets that provide seals between the pop-up electrical outlet and the horizontal surface and/or between the receptacle component and the middle housing. For example, the pop-up electrical outlet may include flanges, rings, and/or other mounting surfaces and associated sealing components (for instance, one or more gaskets) configured to provide a water-resistant seal between the mounting surfaces of the pop-up electrical outlet and the horizontal surface. The middle housing may include additional gaskets to provide a water-resistant seal between one or more housings of the pop-up electrical outlet and the receptacle component. The water-resistant seal reduces or even prevents the ingress of fluid and other environmental elements into the pop-up electrical outlet. The pop-up electrical outlet is configured to be compliant with National Electrical Code (NEC), UL, ETL, and/or other required regulations for countertop electrical outlets.

In various embodiments, the middle housing may include a section where external conductors can be terminated to the pop-up electrical outlet conductors, for instance, using wiring termination elements. In some embodiments, a flexible conductor may be arranged within the pop-up electrical outlet, for instance, fixed between the receptacle component and the middle housing.

The receptacle component may include one or more receptacles for receiving a plug to provide power to electrical devices when positioned above the horizontal surface. The receptacle component may be configured to move vertically up and down within the middle housing to positions above and below (or flush with or recessed in) the horizontal surface. The receptacle component may be engaged with one or more guides configured to align the receptacle component on a defined travel path and guide the movement of the receptacle component within the middle housing along the travel path. The receptacle component may include locking features configured to lock or hold the position of the receptacle component with respect to the middle housing and/or the lower housing.

The lower housing may be coupled to a bottom portion of the middle housing. The lower housing may be configured to provide locking and guiding functionality for the receptacle component. For example, the lower housing may include mechanisms such as guides, latches, and/or other components responsible for locking and positioning the receptacle body in different positions or states. For example, with respect to the guiding functionality, the ends of the one or more guides may be coupled to a bottom inner surface of the lower housing. In another example, with respect to the locking functionality, a portion of the receptacle component may be configured to be releasably locked or otherwise engaged with a corresponding latching feature arranged in the lower housing, for instance, when the receptacle component is fully retracted into the pop-up electrical outlet. The positioning of the locking and guiding features within the lower housing allows for, among other things, the internal wiring and other structural components to be positioned in the middle housing and/or receptacle component to reduce the overall profile of the device and to reduce the strain on internal electrical wiring.

In various embodiments, the receptacle component may be configured to move between multiple distinct positions or states. In some embodiments, the positions may include a retracted state, an intermediate state, and an extended state. In the retracted state, the receptacle component is fixed at a minimum height. In some embodiments, in the retracted state, the receptacle component may be releasably coupled to the lower housing. For example, a locking projection of the receptacle component may be releasably coupled to a corresponding latch of the lower housing. In some embodiments, in the retracted state, only a top portion of the receptacle component may be visible and accessible through the opening in the horizontal surface. In some embodiments, the top portion of the receptacle component exposed when the receptacle component is in the retracted state may be flush or substantially flush with the upper side of the horizontal surface (or a mounting surface of the middle housing).

In the intermediate state, a portion of the receptacle component may be exposed above the upper side of the horizontal surface. In some embodiments, in the intermediate state, the receptacle component is extended to allow access for a user to lift the receptacle component to the extended state. In various embodiments, in the intermediate state, one or more of the receptacles of the receptacle component are inaccessible, for instance, arranged below the horizontal surface.

In the extended state, the receptacle component is releasably locked in place at a maximum height with all receptacles exposed above the horizontal surface. In some embodiments, a locking feature may be arranged within the cavity of the middle housing that is configured to releasably hold the receptacle component in the extended state.

The pop-up electrical outlet of the described embodiments may provide multiple technological advantages over electrical outlet systems, including conventional systems configured for installation in a horizontal surface and/or pop-up installations. One non-limiting example of a technological advantage may include providing a pop-up electrical outlet form factor with reduced physical dimensions compared with conventional pop-up electrical outlets, including reduced profile and height characteristics. The reduced physical dimensions may be facilitated by the specific configuration of locking and/or guiding features in a bottom housing of the pop-up electrical outlet according to some embodiments. In addition, or alternatively, the reduced physical dimensions may be facilitated by the specific configuration of flexible wiring within the housings and other components of the pop-up electrical outlet.

Another non-limiting example of a technological advantage may include reduced or even eliminated strain on internal electrical components, such as wiring, terminal connections, and/or the like due to the improved configuration of the pop-up electrical receptacle components, including moveable components. An additional non-limiting example of a technological advantage may include improved water resistance of a pop-up electrical outlet compared with conventional systems. Additional technological advantages of pop-up electrical outlets according to various embodiments would be recognized by those of skill of the art in view of the present disclosure.

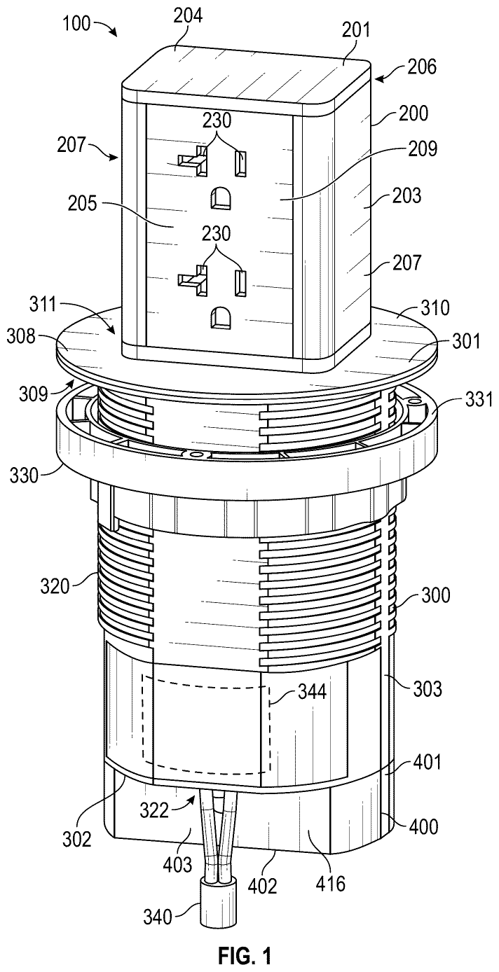

FIG. 1 depicts a perspective front view of an illustrative example of a pop-up electrical outlet in accordance with the present disclosure.

As shown in FIG. 1, a pop-up electrical outlet 100 may include a receptacle component (or upper housing or upper body) 200, a middle housing (or middle body) 300, and a lower housing (or lower body) 400. In the example of FIG. 1, the pop-up electrical outlet 100 is in the extended state.

The receptacle component 200 may include a main body 203 having a top 201, a bottom 202, a front 205, a back 206, and lateral sides 207. The front 205 may include or may be a receptacle cover or cover plate 209. The top 201 may have an upper surface 204. In some embodiments, the upper surface 204 may be a flat or substantially flat surface arranged in parallel with the horizontal surface when the pop-up electrical outlet 200 is installed. One or more receptacles 230 may be arranged within the body 203 to receive a plug to power an electrical device. The receptacles 230 may be accessible via openings or inlets arranged on the front 205. In some embodiments, the receptacles 230 may be or may include electrical receptacles. In various embodiments, the receptacles 230 may be or may include a duplex receptacle with two electrical outlets oriented vertically. In exemplary embodiments, the receptacles may be or may include other connection interfaces such as, without limitation, USB, Mini-USB, USB-C, and/or the like.

The middle housing 300 may include a main body 303 having a top 301 and a bottom 302. A flange 310 may be arranged at the top 301 of the middle housing 300. In some embodiments, the flange 310 may be configured as a mounting surface for mounting the pop-up electrical outlet 100 to a horizontal surface. The flange 310 may have an upper surface 308 and a bottom surface 309. An opening 311 may be arranged in the top 301 of the middle housing 300. In various embodiments, the opening 311 may be sized, shaped, and otherwise configured to allow the receptacle component 200 to pass through the opening 311 and to be arranged within the opening 311 in a water-resistant relationship.

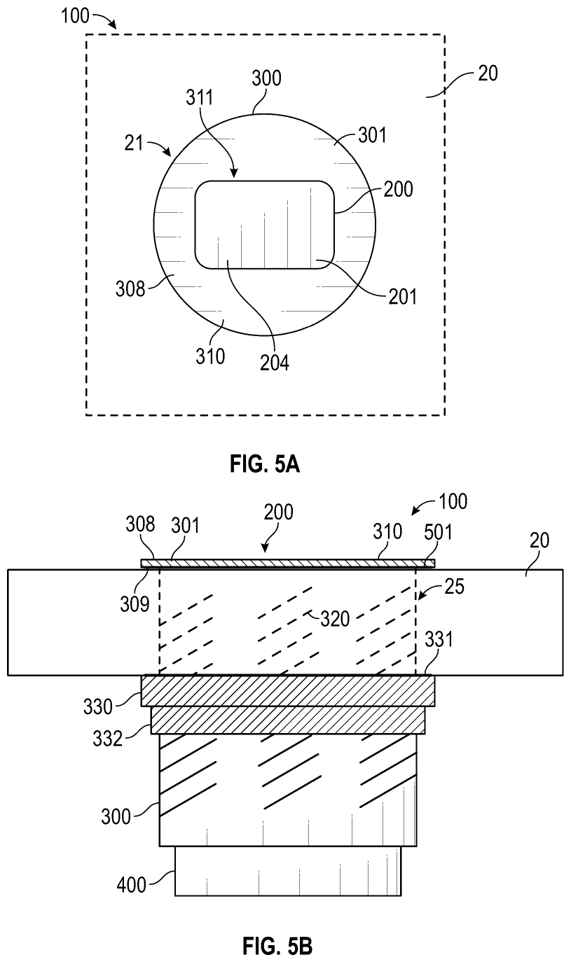

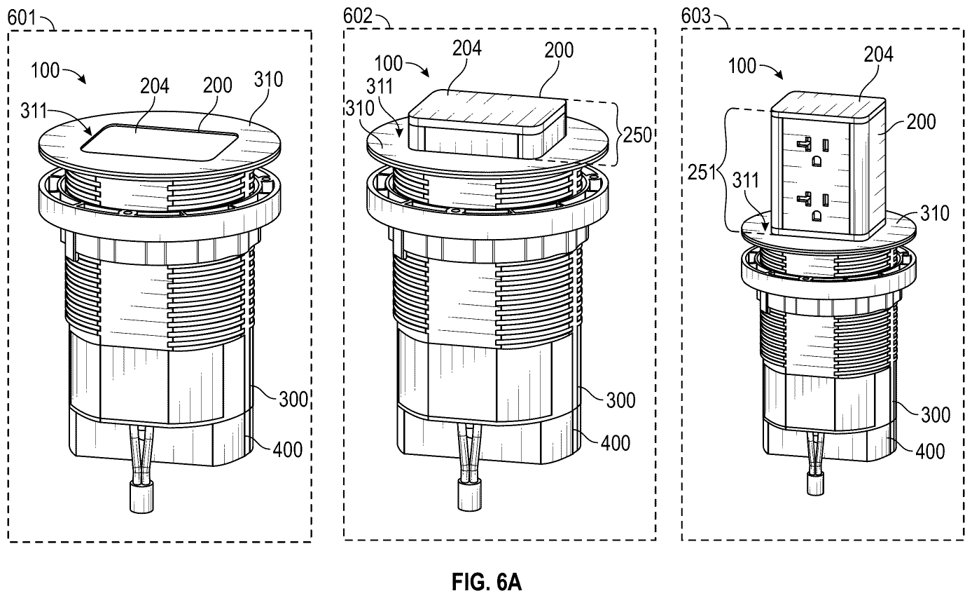

The main body 303 may include threads 320 arranged on at least a portion of an outer surface thereof. The threads 320 may be configured to engage with corresponding threads (not shown, see threads 321 of FIG. 5) of a threaded portion 332 of a ring 330 sized and configured to be positioned around the main body 303. The ring 330 may have an upper surface 331 orientated toward the bottom surface 309. A conductor opening 322 may be arranged at or near the bottom 302 for receiving external conductors 340 from a power source.

The lower housing 400 may include a main body 403 having a top 401 and a bottom 402. The top 401 of the lower housing 400 may be coupled to the bottom 302 of the middle housing 303. In some embodiments, for example, the lower housing 400 may be configured to be coupled to the middle housing 300 via a friction fit, snap fit, clips, latches, fasteners, and/or the like. In various embodiments, a portion of the main body 403 may be formed with a flat, cut-out surface 416 configured, for example, to provide clearance for the external conductors 340.

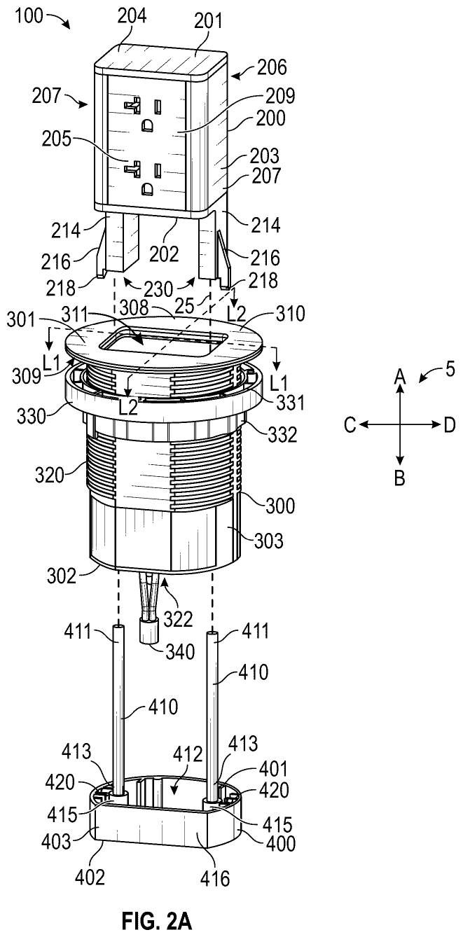

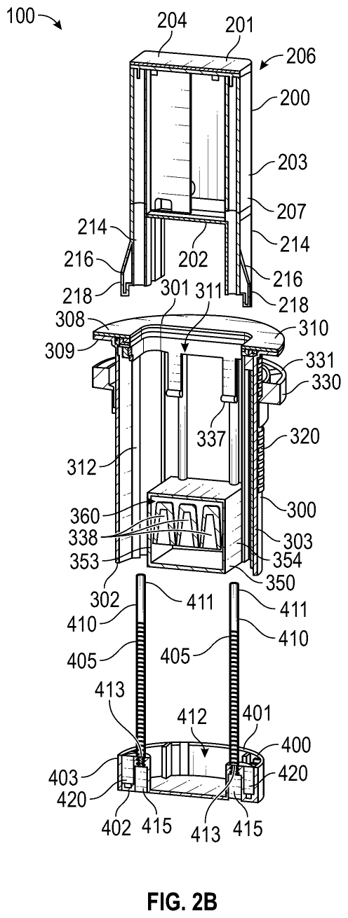

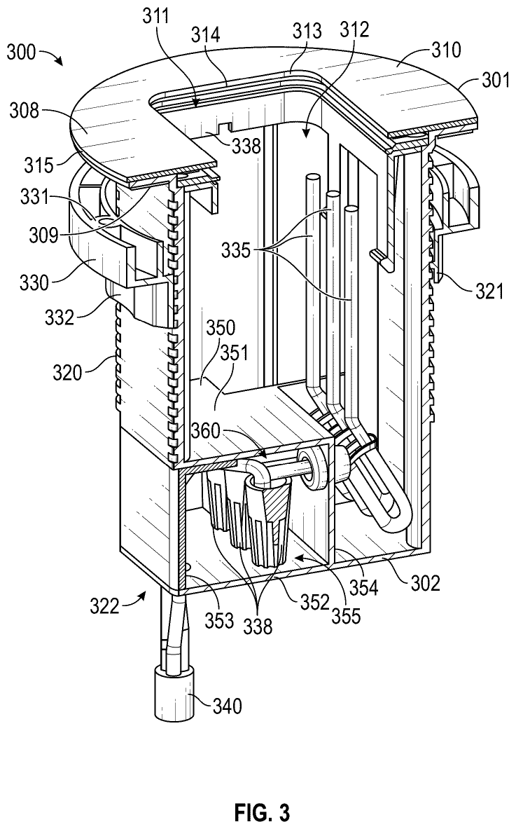

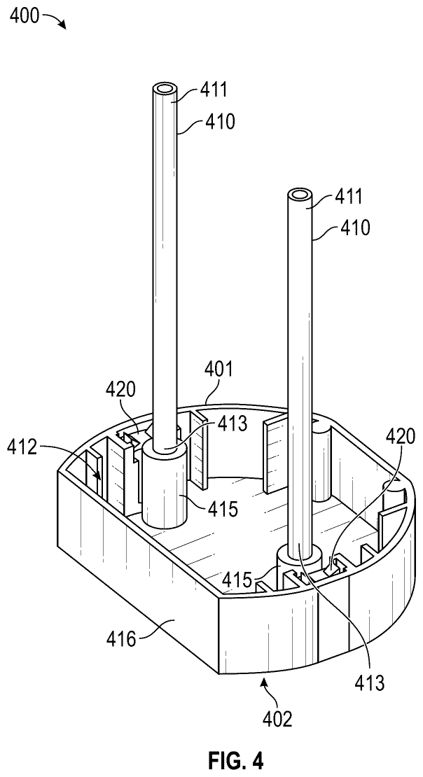

FIG. 2A depicts an exploded perspective front view of an illustrative example of a pop-up electrical outlet in accordance with the present disclosure and FIG. 2B depicts an exploded perspective sectional view along line L1-L1 of FIG. 2A. FIG. 3 depicts a perspective sectional view of a middle housing in accordance with the present disclosure along line L2-L2 of FIG. 2A. FIG. 4 depicts a perspective view of a lower housing in accordance with the present disclosure.

Referring to FIGS. 1-4, the receptacle component 200 may include one or more retracted locking assemblies that include one or more locking components 216. In some embodiments, the locking components 216 may extend from the bottom 202 of the main body 203. In various embodiments, the locking components 216 may extend from sides 207 and/or sidewalls 214 projecting from one or more portions of the main body 203. In some embodiments, the locking components 216 may extend from or be coupled to sides 207 of the main body 203. The retracted locking assembly and/or elements thereof may be arranged in any position or relationship with the receptacle component 200 that allows the retracted locking assembly and/or elements thereof to become releasably engaged with corresponding latching components 420, for instance, arranged in the lower housing 400 when the receptacle component 200 is in the retracted state.

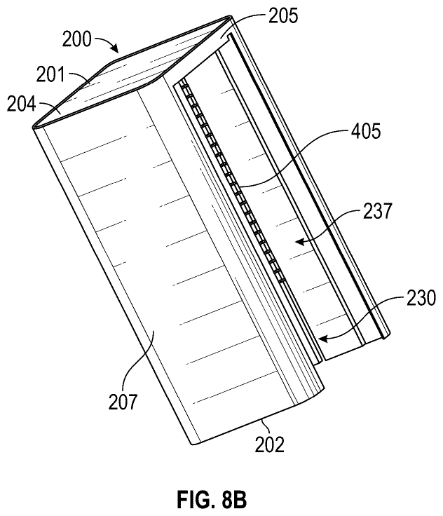

The retracted locking assembly may have different configurations, shapes, locations, elements, and/or the like in various embodiments (see also, for example, FIG. 8A). For instance, in the embodiment of FIG. 2A, the retracted locking assembly may include locking components 216 formed as projections, ridges, or fins. In another example, the locking components 216 may include projections 218, such as feet, flanges, ridges, steps, and/or the like.

The latching components 420 may have different configurations, shapes, locations, elements, and/or the like in various embodiments. For example, in some embodiments, the latching components 420 may be positioned in the lower housing 400. In other embodiments, the latching components 420 may be arranged in the middle housing 300.

In various embodiments, the locking components 216 and/or projections 218 may be arranged on lower portions of the sides 207 of the receptacle component 200. The retracted locking assembly may be configured to be releasably locked, affixed, coupled, or otherwise fixedly engaged with a portion of the latching components 420, thereby releasably affixing the receptacle component 200 within the pop-up electrical outlet 100 when in the retracted state.

The corresponding latching components 420 may be arranged within an interior cavity of a housing (for instance, the middle housing 300 or the lower housing 400) at the outer perimeter of the housing. For example, corresponding latching components 420 may be arranged within an interior cavity 412 of the bottom housing 400. In another example, corresponding latching components 420 may be arranged within an interior cavity 312 of the middle housing 300. In this manner, the locking components for locking the receptacle component 200 in the retracted position may be arranged within the pop-up electrical outlet 100, but at an outer perimeter of the interior space of the middle housing 300 or the lower housing 400, leaving the interior area clear of the locking features (see, for example, FIG. 8A). The retracted locking assembly locking may have any configuration sufficient to be releasably attached to the latching components 420, and vice versa. The components 216 and/or projections 218 may have any configuration sufficient to be releasably attached to the latching components 420, and vice versa.

Although the present disclosure describes two retracted locking assemblies, two locking components 216, and two corresponding latching components 420, embodiments are not so limited, as more or fewer (i.e., one) retracted locking assembly, locking components 216, and latching components 420 may be used according to some embodiments.

In various embodiments, a portion of the retracted locking assembly may be received within the latching components 420. Each of the latching components 420 may include an engagement element (not shown), such as a resilient latch, ledge, shoulder, projection, clip, and/or the like configured to form a latching engagement between the latching components 420 and a portion of the locking components 216 and/or projections 218. In one embodiment, the projections 218 extending from the locking components 216 may form a releasable engagement with the latching components 420.

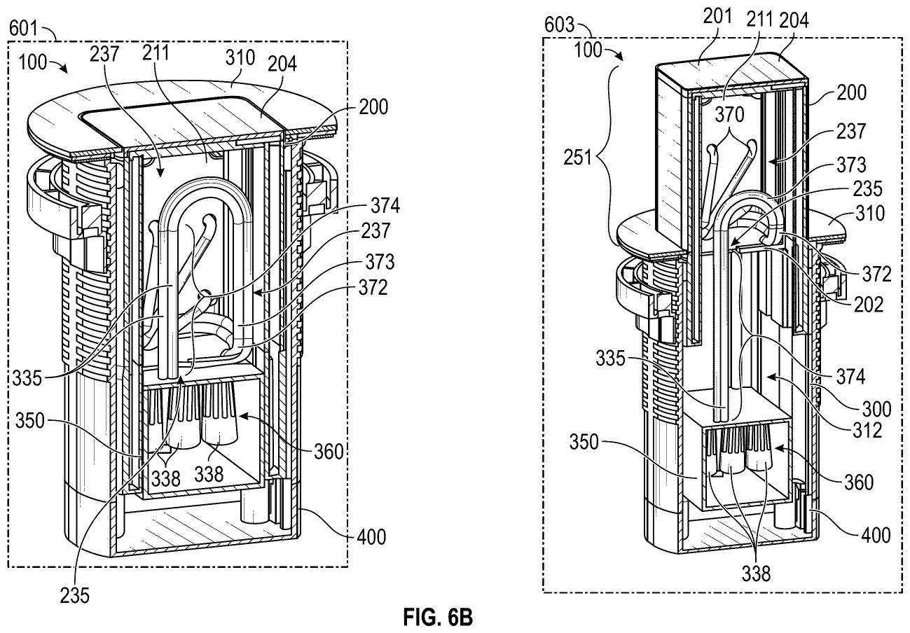

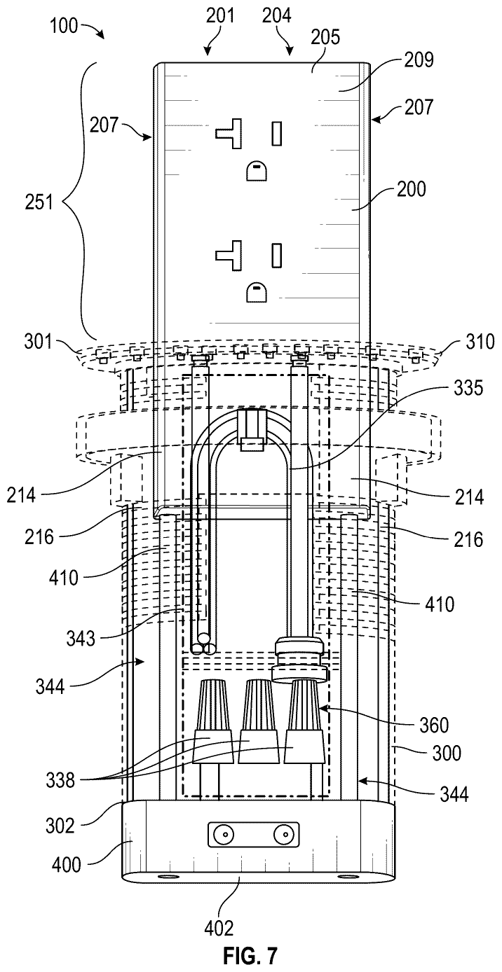

In general, a releasable engagement may include a coupling between the retracted locking assembly and the latching components 420 that may be disengaged via manual manipulation by a user. In various embodiments, the releasable engagement may be or may include a push-to-release engagement between the latching components 420 and the retracted locking assembly. In some embodiments, the releasable engagement between the receptacle component 200 and the latching components 420 may be formed when the receptacle component 200 is in the retracted state (see, for example, FIG. 6A).

One or more biasing components 405 may be configured to bias the receptacle component 200 in a vertically or longitudinally upward direction. With reference to directional indicator 5 of FIG. 2A, in the present disclosure, the relative positions and movements of components are described with references to a vertical or longitudinal axis A-B and a horizontal, lateral, or “left-to-right” axis C-D orthogonal to the vertical axis A-B. The terms “vertically higher” or “longitudinally higher” mean moving in a direction or substantially in a direction from B to A (i.e., away from the lower housing 400 and toward surface 204). The terms “vertically lower” or “longitudinally lower” mean moving in a direction or substantially in a direction from A to B (i.e., from surface 204 toward the lower housing 400).

In some embodiments, the biasing components 405 may be or may include a spring or other resilient element configured to bias or push the receptacle component 200 vertically upward (i.e., in a direction away from the lower housing 400). In some embodiments, the biasing components 405 may be arranged within one or more of the receptacle component 200, the middle housing 300, and/or the lower housing 400. In some embodiments, the biasing components 405 may be configured to be arranged around guides 410. In various embodiments, the biasing components 405 may be arranged or configured to be received, at least partially, in openings or channels formed within the receptacle component 200 (see, for example, FIG. 8B).

When the receptacle component 200 is in the retracted state and releasably locked with the latching components 420, the biasing components 405 are fully or partially contracted and pushing on the receptacle component 200 in a vertically upward direction. In the retracted state, the receptacle component 200 is held in place via the releasable engagement with the latching components 420. For example, the locking components 216 and/or projections 218 are latched with the latching components 420 when the receptacle component 200 is in the retracted state.

When the receptacle component 200 is locked in the retracted state, a user can push down on the receptacle component 200 to cause the retracted locking assembly to become disengaged from the latching components 420 (for instance, releasing the push-to-release engagement). The biasing force by the biasing components 405 when the retracted locking assembly becomes disengaged from the latching component 420 causes the receptacle component 200 to be pushed vertically upward, for example, into an intermediate state (see, for example, FIG. 6A).

In some embodiments, one or more guides 410 may be configured to align and guide the vertical up and down movement of the receptacle component 200. In various embodiments, the guides 410 may be or may include rods, bars, shafts, posts, projections, and/or the like. In some embodiments, the guides 410 may be cylindrical or have a generally cylindrical shape. The guides 410 may include an upper end or portion 411 and a lower end or portion 413. The lower portion 413 may be configured to be coupled to posts, supports, or other structures 415 within the interior of the pop-up electrical outlet 100. In some embodiments, the supports 415 may be arranged within the lower housing 400. In various embodiments, the supports 415 may be arranged within the middle housing 300. In some embodiments, the guides 410 may be stationary, for instance, fixedly attached within the pop-up electrical outlet 100. For instance, the lower portion 413 of the guides 410 may be fixedly coupled to the supports 415 within the lower portion 400.

The receptacle component 200 may include openings 230 configured to receive the upper portion 411 of the guides 410. In some embodiments, the receptacle component 200 may include corresponding channels, grooves, passageways, slots, and/or the like (not shown, see, for example, channel 231 of FIG. 8B) within the main body 203. The channels may be configured to receive the guides 410 and allow the receptacle component 200 to slidably travel vertically up and down within the middle housing 300 riding along the guides 410. In some embodiments, the sidewalls 214 of the receptacle component may include corresponding openings 230 and channels (see, for example, FIG. 8A). In general, in various embodiments, the guides 410 may operate to control the travel path 25 of the receptacle component 200, for instance, maintaining a vertically straight or substantially straight and rigid or substantially rigid travel path 25 for the receptacle component 200.

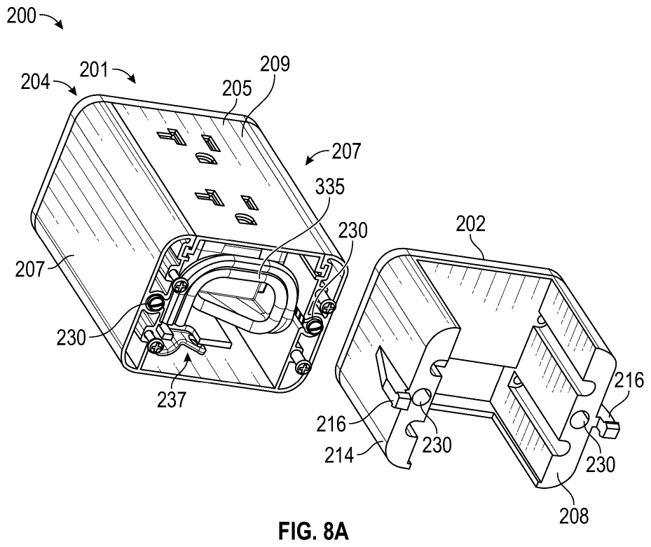

The supports 415 may be arranged within an interior cavity of the lower housing 400 at the outer perimeter of the lower housing 400. In this manner, the guides 410 may be arranged within the pop-up electrical outlet 100, but at an outer perimeter of the interior, leaving the interior area clear of the guiding features (see, for example, FIG. 7).

The middle housing 300 may include an interior cavity 312 housing internal conductors or wires 335 electrically coupled to the external conductors 340 via a terminal component 360. For example, in some embodiments, the external conductors 340 may enter the middle housing 300 and be coupled with wire terminals or connectors 338 to provide power to the pop-up electrical outlet 100. The internal conductors 335 may be electrically coupled to the 230 receptacles of the receptacle component 200. In some embodiments, the receptacles 230 may be arranged within a receptacle component 211. In various embodiments, the internal conductors 335 may be electrically coupled to a terminal component 360. In some embodiments, the terminal component 360 may include independent wire connectors 338, such as insulated wire connectors or terminals. In various embodiments, the wire terminals 338 may be arranged within a terminal housing 350 having a terminal cavity 355 defined by an upper cavity wall 351, a bottom 352 (which may be or may include the bottom 302 of the middle housing 300), a first sidewall 353, and a second sidewall 354. The first sidewall 353 and/or the second sidewall 354 may be or may include an internal sidewall of the middle housing 300. In some embodiments, a removable cover 344 may be arranged on the body 303 of the middle housing 300 to provide access to the terminal housing 350 and, therefore, the terminal component 360, wire terminals 338, internal conductors 335, and/or the like.

The configuration of the internal conductors 335 (see, for example, FIG. 6B), facilitated by the arrangement of the guides 410 and the extended and retracted locking assemblies as described in the present disclosure, allows for the terminal component 360 to use independent wire connectors 338, such as insulated connectors. In various embodiments, terminal component 360 may be or may include one independent terminal 338 for each conductor 335. In various embodiments, the terminal component 360 may be a non-terminal block component that does not use a terminal block. Accordingly, a terminal block, junction block, and/or the like is not required, as with conventional outlets, including pop-up electrical outlets or other outlets installed in horizontal surfaces. In some embodiments, a terminal block is not used for conductor or wire connections for the pop-up electrical outlet 100.

The use of independent wire connectors 338 in embodiments of the present disclosure instead of a terminal block allows for a reduced-size form factor than conventional outlets, including pop-up electrical outlets. In addition, the use of independent wire connectors 338 allows for wiring configurations within a pop-up electrical outlet that are lower-cost, more flexible, safer, and provide for easier installation than conventional outlets, including pop-up electrical outlets. Furthermore, the use of independent wire connectors 338 configured according to the described embodiments facilitates reduced strain, flexion, and/or tension on the internal conductors 335.

The opening 311 may include an interior sidewall 313. In some embodiments, the sidewall 313 may include or may be coupled with a sealing component 314 configured to form a water-resistant or water-proof seal between the sidewall 313 and the front 205, back 206, and/or sides 207 of the receptacle component 200. In various embodiments, the sealing component 314 may be or may include a gasket, an O-ring, and/or a similar sealing structure. In some embodiments, the sealing component 314 may be formed of rubber, silicon, combinations thereof, and/or other sealing materials. In this manner, the receptacle component 200 may form a water-resistant or water-proof seal with the middle housing 300 when in the extended state, the intermediate state, or the retracted state and when moving between the extended state, the intermediate state, or the retracted state. Accordingly, fluid or particle ingress into the interior of the pop-up electrical outlet 100 and/or components or housings thereof via the opening 311 may be reduced or even completely eliminated.

In some embodiments, the middle housing 300 may include an extended locking assembly that may include extended locking components (or legs), projections, and/or the like configured to lock, hold, or otherwise engage the receptacle component 200 in the extended state. In various embodiments, the extended locking assembly and/or components thereof may be arranged in a perimeter area of the middle housing 300 (for instance, outside of a central area of the middle housing; see, for example, FIG. 7).

When the receptacle component 200 is in the extended state (see, for example, FIG. 6A), a portion of receptacle component 200, for instance, the bottom 202 of the receptacle component 200 (or a portion of the bottom 202) may engage with the extended locking assembly, which operates to rigidly hold the receptacle component 200 in place in the extended state. For example, a portion of the bottom 202 may be seated on feet, ledges, or projections of the extended locking components. In some embodiments, the extended locking component may operate as a seat to hold the receptacle component 200 in place in the extended state. The extended locking component operates to prevent the downward movement of the receptacle component 200 in the absence of an unlocking force pushing vertically downward on the receptacle component 200 when the receptacle component 200 is in the extended state.

When the receptacle component 200 is in the extended state, and engaged with the extended locking assembly, if a user presses down on the top 201 of the receptacle component 200 in a vertically downward direction, the force is transferred to the extended locking assembly, causing the engagement between the extended locking assembly and the receptacle component 200 to be released.

When the user presses on the top 201 of the receptacle component 200 with a sufficient unlocking force, the receptacle component 200 moves in a vertically downward direction within the middle housing 300. When the receptacle component 200 is unseated from or otherwise disengaged from the extended locking assembly, the vertically upward biasing force of the biasing components 405 may be active against the receptacle component, preventing or cushioning the downward movement of the receptacle component 200.

FIG. 5A depicts top-down view of an illustrative example of a pop-up electrical outlet installed in a horizontal surface in accordance with the present disclosure, and FIG. 5B depicts a side view of an illustrative example of a pop-up electrical outlet installed in a horizontal surface in accordance with the present disclosure.

As shown in FIGS. 5A and 5B, a pop-up electrical outlet 100 may be installed within an opening 21 of a horizontal surface 20. For example, the opening 21 may include a hole drilled through the horizontal surface 20, such as a kitchen countertop. In various examples, the opening 21 may be tapered downward. In some examples, the opening 21 may be a circular hole having a circumference that is wider than the circumference of the body 303 of the middle housing, but that is less than the circumference of the flange 310. When installed, the flange 310 may be arranged on, above, or substantially flush with the upper surface of the horizontal surface 20.

During installation, the pop-up electrical outlet 100 may be arranged within an interior space 26 of the hole 21 such that the flange 310 engages an upper side of the horizontal surface 20, for instance, in which the pop-up electrical outlet 100 is essentially hanging from the flange 310. In various embodiments, a sealing element 501 may be arranged within or otherwise associated with the flange 310. The ring 330 may be rotated along the threads 320 to tighten the ring 320 against the lower side of the horizontal surface 20, creating a flanged or bolted joint (i.e., the middle housing 300 and the flange 310 operate as the bolt, and the ring 330 operates as the nut).

In various embodiments, the sealing component 501 may be or may include a gasket, an O-ring, or a similar sealing structure. In some embodiments, the sealing component 501 may be formed of rubber, silicon, combinations thereof, and/or other sealing materials. The tension of the flanged joint between the middle housing 300 and the ring 330 compresses the sealing element 501 to form a water-resistant or water-proof seal between the middle housing 300 (i.e., via the flange 310) and an upper side of the horizontal surface 20. Accordingly, fluid or particle ingress into the interior of the pop-up electrical outlet 100 and/or components or housings thereof via the opening 21 may be reduced or even completely eliminated.

FIG. 6A depicts a front perspective view of positional states of a pop-up electrical outlet in accordance with the present disclosure. FIG. 6B depicts a sectional perspective view of positional states of a pop-up electrical outlet in accordance with the present disclosure. As shown in FIGS. 6A and 6B, the pop-up electrical outlet 100 may be arranged in multiple positions or states. In some embodiments, the states may include a retracted (or fully retracted) state 601, an intermediate state 602, and an extended (or fully extended) state 603.

In the retracted state 601, the receptacle component 200 is fully retracted within the pop-up electrical outlet 100. In some embodiments, in the retracted state 601, the receptacle component 200 is arranged within the middle housing 300. The upper surface 204 may be visible through the opening 311. In various embodiments, the upper surface 204 may be flush or substantially flush with the flange 310 when the receptacle component 200 is in the retracted state 601.

In various embodiments, when the receptacle component 200 is in the retracted state 601, the retracted locking assembly may be releasably engaged with the latching components 420. The biasing components 405 may be pushing on the receptacle component 200 in a vertically upward direction. However, the releasable engagement between the retracted locking assembly and the latching components 420 keeps the receptacle component 200 in the retracted position, for example, with the upper surface 204 flush or substantially flush with the flange 310.

In the retracted state 601, if a user presses down on the upper surface 204 with an unlatching force sufficient to overcome the biasing force of the biasing components 405, the receptacle component 200 (and, therefore, the retracted locking assembly) is forced vertically downward, for example, the top upper surface 204 may be pushed vertically below the flange 310 and/or the upper surface of the horizontal surface. As the receptacle component 200 moves vertically downward, the retracted locking assembly becomes unlatched from the latching components 420. When the retracted locking assembly is freed from the latching components 420, removal of the unlatching force (i.e., the user removes their hand or sufficiently diminishes the downward pushing force) allows the biasing components 405 to push the receptacle component 200 up into the intermediate state 602.

In the intermediate state 602, the receptacle component 200 is not locked, latched, or otherwise engaged with a locking assembly (e.g., latching components or the extended locking assembly). For example, in some embodiments, the receptacle component 200 is being supported (or is balanced or “floating”) on the biasing components 405. In the intermediate state 602, a first or intermediate portion 250 of the receptacle component 200 is visible and accessible above the flange 310. In some embodiments, a receptacle 230 may not be visible/accessible from the intermediate portion 250. In other embodiments, a receptacle 230 (or other connection interface) may be visible/accessible from the intermediate portion 250.

In the intermediate state 602, a user may push vertically downward with a sufficient retracting force (i.e., a force sufficient to overcome the vertically upward biasing force of the biasing components 405) to latch the retracted locking assembly with the latching components 420 to cause the receptacle component 200 to enter the retracted state 601.

In the intermediate state 602, a user may pull vertically upward (for instance, grasping the receptacle component 200 by the intermediate portion 250) on the receptacle component 200 to cause the receptacle component 200 to enter the extended state 603. In some embodiments, an exit prevention element (not shown) such as a tab, flange, shoulder, and/or the like may be arranged at or near the bottom 202 of the receptacle component 200 to prevent the receptacle component 200 from being pulled out of the middle housing 300. In some embodiments, the retracted locking assembly and/or elements thereof may be or may be one of the exit prevention elements. For instance, the exit prevention element may engage with a bottom side (e.g., bottom side 309) of the flange 310 or another portion of the middle housing 300 to prevent vertically upward movement of the receptacle component 200 beyond a maximum extension height.

When the receptacle component 200 is raised above a clearance height of the extended locking assembly, the extended locking assembly may engage with the receptacle component 200. In the extended state 603, the receptacle component 200 may be rigidly or semi-rigidly held in place between the exit prevention components (preventing movement in a vertically upward direction) and the extended locking assembly (preventing movement in a vertically downward direction).

In the extended state 603, an extended portion 251 of the receptacle component 200 is arranged above the flange 310 (and, therefore, the horizontal surface in which the pop-up electrical outlet 100 is installed). In the extended state 603, the receptacles 230 (or other connection interfaces) may be visible and accessible.

When the receptacle component 200 is in the extended state 603, if a user presses down on the top 201 of the receptacle component 200 in a vertically downward direction, the force is transferred to the extended locking assembly, which causes the extended locking assembly to disengage from the receptacle component 200, allowing the receptacle component 200 to move in a vertically downward direction within the middle housing 300 and into the intermediate state 602.

Referring to FIG. 6B, the internal conductors 335 may be or may include flexible wires configured to have portions thereof differentially arranged within the receptacle component 200 and the middle housing 300 in different states, including the retracted state 601 and the extended state 603.

In some embodiments, the internal conductors 335 may be or may include one or more flexible wires. In various embodiments, the internal conductors 335 may include one flexible wire, two flexible wires, or three flexible wires, for instance, a load wire, a line wire, a hot wire, a neutral wire, a ground wire, and/or the like. In various embodiments, a receptacle end 370 of the internal conductors 335 may be electrically coupled to corresponding terminals (not shown) of the receptacle component 200.

In various embodiments, the internal conductors 335 may include one or more affixed portions 372 affixed to an interior surface of the receptacle component 202. For example, in one embodiment, the affixed portions 372 may be affixed to an interior surface of the bottom 202 of the receptacle outlet 200 at one or more affixation points. In various embodiments, the affixed portions 372 may be affixed to or may be additionally affixed to one or more other interior surfaces of the receptacle component 202, such as an interior surface of the top 201, the front 205, the back 206, and/or the lateral sides 207. As the receptacle component 200 travels within the middle housing 300, the affixed portion 372 is moved (for instance, pushed or pulled) in parallel with the receptacle component 200. For example, when the receptacle component 200 transitions from the retracted state 601 to the intermediate state 602 or the extended state 603, the affixed portion 372 moves vertically upward within the pop-up electrical outlet 100. In another example, when the receptacle component 200 transitions from the extended state 603 to the intermediate state 602 or retracted state 601, the affixed portions 372 move vertically downward within the pop-up electrical outlet 100 as the affixed portions 372 are pulled vertically downward by the receptacle component 200.

One or more conductor openings 235 may be arranged in the bottom 202 of the receptacle component 200 that are configured to allow a portion of the internal conductors 335 to travel in and out of the interior space 237 of the receptacle component 200 as the receptacle component 200 moves vertically upward and vertically downward within the middle housing 300. In various embodiments, the conductor openings 235 may be configured to allow portions of the internal conductors 335 to move in and out of the receptacle component 200 without interference.

A first (or receptacle component) length 373 of the internal conductors 335, which includes the affixed portion 372, is enclosed within the receptacle component 200 in all states 601-603. In various embodiments, the first length 373 may be arranged above the middle housing 300 in the extended state 603.

A second (or middle housing) length 374 of the internal conductors 335 may be enclosed within the middle housing 300 in all states 601-603. The second length 374 may be arranged outside of the receptacle component 200, and solely enclosed by the middle housing 300, in the extended state 603. As the receptacle component 200 moves vertically downward (for instance, when traveling from the extended state 603 to the intermediate state 602 or from the intermediate state 602 to the retracted state 601), portions of the second length 374 move into the receptacle component 200. In the retracted state, the second length 374 is enclosed within both the receptacle component 200 and the middle housing 300 (as the receptacle component 200 is enclosed within the middle housing 300).

In various embodiments, at least a portion of the internal conductors 335 may be arranged within a central portion of the middle housing 300 (see, for example, central area 343 of FIG. 7). For example, the second length 374 may be arranged within the central portion of the middle housing 300.

As the receptacle component 200 moves between states 601-603, the second length 374 moves in and out of the receptacle component 200 with minimal flexion, tension, and strain. Accordingly, the pop-up receptacle 100 is able to facilitate movement of the receptacle component 200 within the middle housing in a manner that conserves space while minimizing wiring strain, prolonging the life of the pop-up electrical outlet 100 and minimizing electrical hazards.

FIG. 7 depicts a front view of an illustrative example of a pop-up electrical outlet in accordance with the present disclosure. In FIG. 7, the middle housing 300 is depicted as transparent.

As shown in FIG. 7, a central area 343 within the middle housing 300 may be free of structures devoted to guiding (e.g., guides 410), biasing (e.g., springs 405), and/or locking or latching assemblies (e.g., the extended locking assembly, the retracted locking assembly, and/or components thereof). The guiding, biasing, locking, and/or latching features may be arranged within a perimeter area 344 of the middle housing 300 (for instance, the space between the central area 343 and the interior sidewall of the middle housing 300). In some embodiments, the central area 343 may include an area within the middle housing 300 inside of an area of travel of the sidewalls 214 of the receptacle component. The perimeter area 344 may include an area from the sidewalls 214 (from an outside surface (a surface facing the interior sidewall of the middle housing 300) of the sidewalls 214) to the interior sidewall of the middle housing 300.

As a result, in various embodiments, the central area 343 may be free for use for conductors, wiring, and/or electrical connections. Accordingly, a pop-up electrical outlet 100 according to some embodiments may require less space for component movement and/or allow for less flexion, strain, and/or tension on internal wiring compared with conventional pop-up electrical outlets.

FIGS. 8A and 8B depict perspective views of the receptacle component with certain components removed. In FIG. 8A, a base 208 supporting the sidewalls 214 has been removed, and in FIG. 8B, the base 208, front 205, and internal structures have been removed.

In various embodiments, channels, slots, grooves, and/or the like 231 may be arranged within the interior space 237 of the receptacle component 200 for receiving the guides 410. For example, in various embodiments, channels 231 may be formed in the internal sidewalls of the sides 207 for receiving the guides 410. In some embodiments, the channels 231 may also be formed within the sidewalls 214. The channels 231 may be positioned and shaped to slidably move vertically up and down around the guides 410. For example, as the receptacle component 200 moves vertically up and down within the middle housing 300, the channels 231 may slide vertically up and down over the stationary guides 410. In general, the engagement of the guides 410 within the channels 231 may operate to control the travel path 25 of the receptacle component 200, for instance, maintaining a smooth travel motion along a vertically straight or substantially straight and rigid or substantially rigid travel path 25 for the receptacle component 200. For example, in various embodiments, the channels 231 may have an inner circumference that is greater than an outer circumference of the guides 410 within a tolerance sufficient to support rigid yet fluid travel of the channels 231 over the guides 410 as the receptacle component 200 moves within the middle housing 300.

In various embodiments, the biasing components 405 may be arranged in different positions within the pop-up electrical outlet 100 depending on the particular configuration of the pop-up electrical outlet 100. For instance, in various embodiments, the biasing components 405 may be or may include cylindrical springs arranged longitudinally around the guides 410 (see, for example, FIG. 2B). In an embodiment in which the biasing components 405 are arranged around the guides 410, a top portion of the biasing components 405 may engage with the bottom 202 of the receptacle component 200 to provide a biasing force vertically upward against the receptacle component 200. For example, the bottom 202 of the receptacle component 200 may engage the biasing components 405 as the receptacle component 200 travels vertically downward within the middle housing 300 to cause or increase the biasing force of the biasing components 405 on the receptacle component 200 (for instance, in the retracted state 601 and/or the intermediate state 602).

In some embodiments, the biasing components 405 may be or may include cylindrical springs arranged within the channels 231. In various embodiments, the upper ends 411 of each of the guides 410 may engage with lower ends of the biasing components 405. For example, as the guides 410 move vertically upward into the channels 231 (i.e., as the receptacle component 200 moves vertically downward within the middle housing 300), the biasing components 405 are compressed by the guides 410, thereby causing or increasing the biasing force of the biasing components 405 on the receptacle component 200 (for instance, in the retracted state 601 and/or the intermediate state 602).

While specific embodiments have been described in detail, it will be appreciated by those skilled in the art that various modifications and alternatives to those details could be developed in light of the overall teachings of the present disclosure. Accordingly, the particular arrangements disclosed are meant to be illustrative only and not limiting as to the scope of disclosed concept which is to be given the full breadth of the claims appended and any and all equivalents thereof.

What is claimed is:

1. A pop-up electrical outlet, comprising:
a middle housing configured to be installed within an opening of a horizontal surface;
a lower housing coupled to a bottom of the middle housing;
a receptacle component comprising at least one electrical receptacle and configured to slidably move within the middle housing vertically upward to an extended state above the horizontal surface and vertically downward to a retracted state below the horizontal surface, wherein movement of the receptacle component within the middle housing is guided by at least one guide extending vertically within the middle housing, the at least one guide having a lower end coupled to the lower housing and an upper end configured to be received within a channel arranged within a lateral wall of the receptacle component; and
at least one retracted locking assembly arranged on an external lateral surface of the receptacle component, the at least one retracted locking assembly configured to be releasably latched with a latching component arranged in the lower housing when the receptacle component is in the retracted state.

2. The pop-up electrical outlet of claim 1, further comprising a plurality of independent wire terminals arranged within the middle housing to electrically connect external conductors of a power source to internal conductors electrically coupled to the at least one electrical receptacle.

3. The pop-up electrical outlet of claim 1, further comprising at least one spring arranged around the at least one guide, the at least one spring configured to bias the receptacle component vertically upward.

4. The pop-up electrical outlet of claim 1, wherein the receptacle component is configured to be arranged in an intermediate state between the extended state and the retracted state, the receptacle component supported at least partially by the at least one spring in the intermediate state with an intermediate portion of the receptacle component arranged above the horizontal surface.

5. The pop-up electrical outlet of claim 1, further comprising internal conductors configured to electrically connect the at least one electrical receptacle to a power source, the internal conductors extending within a central area of the middle housing, wherein the at least one guide, and the at least one retracted locking assembly are arranged within the middle housing in a perimeter area outside of the central area.

6. The pop-up electrical outlet of claim 5, the internal conductors comprising a first length enclosed within the receptacle component in each of the extended state, the intermediate state, and the retracted state, the first length having one or more affixed portions affixed to an interior surface of the receptacle component to cause the first length to move in parallel with the receptacle component.

7. The pop-up electrical outlet of claim 6, the internal conductors comprising a second length enclosed within a central area of the middle housing in each of the extended state, the intermediate state, and the retracted state, wherein the second length is configured to move into the receptacle component through openings in a bottom of the receptacle component as the receptacle component moves vertically downward within the middle housing.

8. The pop-up electrical outlet of claim 7, wherein:
the first length is arranged above the middle housing when the receptacle component is in the extended state, and
the second length is arranged outside of and below the receptacle component when the receptacle component is in the extended state.

9. The pop-up electrical outlet of claim 7, wherein the second length is enclosed within both the receptacle component and the middle housing when the receptacle component is in the retracted state.

10. The pop-up electrical outlet of claim 1, wherein the receptacle component is configured to move into and out of the middle housing via a middle housing opening, the middle housing opening having an internal sidewall associated with a sealing component configured to form a water-resistant seal between the sidewall and each of a plurality of sides of the receptacle component.

11. A pop-up electrical outlet, comprising:
a middle housing configured to be installed within an opening of a horizontal surface;
a lower housing coupled to a bottom of the middle housing;
a receptacle component comprising at least one electrical receptacle and configured to slidably move vertically within the middle housing to an extended state above the horizontal surface, a retracted state below the horizontal surface, and an intermediate state between the extended state and the retracted state; and
internal conductors configured to electrically connect the at least one electrical receptacle to a power source, the internal conductors comprising:
a first length enclosed within the receptacle component in each of the extended state, the intermediate state, and the retracted state, the first length having one or more affixed portions affixed to an interior surface of the receptacle component to cause the first length to move in parallel with the receptacle component, and
a second length enclosed within a central area of the middle housing in each of the extended state, the intermediate state, and the retracted state, wherein the second length is configured to move into the receptacle component through openings in a bottom of the receptacle component as the receptacle component moves vertically downward within the middle housing.

12. The pop-up electrical outlet of claim 11, further comprising a plurality of independent wire terminals arranged within the middle housing to electrically connect external conductors of a power source to internal conductors electrically coupled to the at least one electrical receptacle.

13. The pop-up electrical outlet of claim 11, wherein the first length is arranged above the middle housing when the receptacle component is in the extended state.

14. The pop-up electrical outlet of claim 11, wherein the second length is arranged outside of and below the receptacle component when the receptacle component is in the extended state.

15. The pop-up electrical outlet of claim 11, wherein the second length is enclosed within both the receptacle component and the middle housing when the receptacle component is in the retracted state.

16. The pop-up electrical outlet of claim 11, wherein movement of the receptacle component within the middle housing is guided by at least one guide extending vertically within the middle housing, the at least one guide having a lower end coupled to the lower housing and an upper end configured to be received within a channel arranged in a lateral side wall of the receptacle component.

17. The pop-up electrical outlet of claim 16, further comprising at least one retracted locking assembly arranged on an external lateral surface of the receptacle component, the at least one retracted locking assembly configured to be releasably latched with a latching component arranged in the lower housing when the receptacle component is in the retracted state.

18. A receptacle component for a pop-up electrical outlet, comprising:
a body having a pair of opposing lateral walls and a front face orthogonal to the lateral walls, the body configured to slidably move vertically within a middle housing to an extended state above the horizontal surface, a retracted state below the horizontal surface, and an intermediate state between the extended state and the retracted state;
at least one electrical receptacle accessible via the front face of the body;
a pair of channels, each of the pair of channels arranged within one of the pair of opposing lateral walls and configured to receive one of a pair of guides to guide movement of the receptacle component within the middle housing;
at least one retracted locking assembly arranged on an external lateral surface of the receptacle component, the at least one retracted locking assembly configured to be releasably latched with a latching component arranged in the lower housing when the receptacle component is in the retracted state; and
at least one spring arranged around the at least one guide, the at least one spring configured to bias the receptacle component vertically upward.

19. The receptacle component for a pop-up electrical outlet of claim 18, wherein the receptacle component is configured to be arranged in the intermediate state supported at least partially within the middle housing by the at least one spring with an intermediate portion of the receptacle component arranged above the horizontal surface.

20. The receptacle component for a pop-up electrical outlet of claim 18, wherein the pair of channels and the least one retracted locking assembly are configured to move within a perimeter area of the middle housing, external to a central area of the middle housing having internal conductors arranged therein.
